(19) United States
(12) Patent Application Publication
(10) Pub. No.: US 2002/0131159 A1
(43) Pub. Date: Sep. 19, 2002

(54) Dynamic spectral filters with internal control

(76) Inventors: Jun Ye, Palo Alto, CA (US); Yu Cao, Cupertino, CA (US); Gordon C. Wilson, New York, NY (US)

Correspondence Address: G VICTOR TREYZ, FISH & NEAVE, 1251 AVENUE OF THE AMERICAS, HOUSTON, TX, 10020-1104, US

(21) Appl. No.: 09/877,129

(22) Filed: Jun. 11, 2001

Related U.S. Application Data
(60) Provisional application No. 60/276,111, filed on Mar. 16, 2001.

(51) Int. Cl. H01S 3/00

(52) U.S. Cl. 359/337.2

(57) ABSTRACT

A calibrated dynamic spectral filter is provided. Test and programming equipment may be used to characterize the spectral performance of the dynamic filter during manufacturing. The performance measurements may be used to generate calibration data. The calibration data may be stored in memory in the dynamic filter by the test and programming equipment. The calibration data may be used to calibrate the operation of the dynamic filter when the dynamic filter is used in optical equipment such as in an optical amplifier in a fiber-optic communications network.

This application claims the benefit of provisional patent application No. 60/276,111, filed Mar. 16, 2001.

### BACKGROUND OF THE INVENTIONI

The present invention relates to dynamic spectral filters, and more particularly, to dynamic spectral filters that may be internally controlled and to dynamic spectral filters that may be calibrated for use in optical amplifiers or other equipment in fiber-optic communications networks.

Dynamic spectral filters are filters that have controllable spectral properties. Dynamic spectral filters may be used in a variety of applications. For example, dynamic spectral filters may be used as midstage components in optical amplifiers in fiber-optic communications systems. A dynamic spectral filter in an optical amplifier may be used to adjust the gain spectrum or output power spectrum of the amplifier.

Dynamic spectral filters may be based on dynamic filter elements formed from microelectromechanical systems (MEMS) devices or other controllable optical components.

Due to manufacturing variations, the performance of each dynamic spectral filter element may be slightly different. For example, the amount of light that is transmitted through the filter as a function of wavelength and temperature may differ from element to element. This may lead to variations in the transmission of the dynamic filter element and any uncalibrated dynamic spectral filter constructed from the dynamic filter element during use in an optical system.

It is an object of the present invention to provide dynamic spectral filters that include control circuitry for controlling the operation of the components in the filters.

It is also an object of the present invention to provide calibrated dynamic spectral filters.

It is also an object of the present invention to provide ways in which to characterize the performance of dynamic filters and to calibrate the dynamic filters during manufacturing.

### SUMMARY OF THE INVENTION

These and other objects of the invention are accomplished in accordance with the present invention by providing dynamic spectral filters. The dynamic spectral filters may be based on dynamic spectral filter elements such as microelectromechanical systems (MEMS) devices, may be based on acoustooptic devices (e.g., acoustooptic fiber devices), may be based on thermo-optic arrayed waveguide devices, may be based on liquid crystals, may use electrooptic devices, may be based on semiconductor devices, may be based on electrooptically-induced or mechanically-induced gratings, or may be based on any other suitable dynamic filter arrangement.

The performance characteristics of the dynamic spectral filter elements may differ from each other due to manufacturing variations. Accordingly, each dynamic spectral filter element may be characterized to generate corresponding calibration data.

The calibration data may be stored in memory in the dynamic spectral filter in which the characterized dynamic spectral filter element is used. The dynamic spectral filter may have control circuitry that uses the calibration data to provide a calibrated interface between the filter element and other components in an optical amplifier or other optical network equipment.

The dynamic spectral filter may have detectors that the control circuitry may use to measure spectral information during operation of the dynamic spectral filter. The control circuitry may use feedback signals from the detectors in controlling the dynamic filter element.

Further features of the invention and its nature and various advantages will be more apparent from the accompanying drawings and the following detailed description of the preferred embodiments.

### BRIEF DESCRIPTION OF THE DRAWINGS

FIG. 1 is a schematic diagram of an illustrative fiber-optic communications link including optical amplifiers that may include dynamic spectral filters in accordance with the present invention.

FIG. 2 is a schematic diagram of an illustrative optical amplifier having a dynamic spectral filter in accordance with the present invention.

FIG. 3 is a schematic diagram of an illustrative dynamic filter in accordance with the present invention.

FIG. 4 is a more detailed schematic diagram of an illustrative dynamic filter in accordance with the present invention.

FIG. 5 is a schematic diagram of an illustrative arrangement for testing and calibrating dynamic filters in accordance with the present invention.

FIG. 6a is a schematic diagram of an illustrative measured spectrum and ideal desired spectrum in accordance with the present invention.

FIG. 6b is a schematic diagram showing some of the calibration data that may be generated for a dynamic filter having the illustrative spectral characteristics of FIG. 6a.

FIG. 6c is a schematic diagram of an illustrative measured difference spectrum and an ideal difference spectrum in accordance with the present invention.

FIG. 6d is a schematic diagram showing some of the calibration data that may be generated for a dynamic filter having the illustrative spectral characteristics of FIG. 6c.

FIG. 7 is a flow chart of illustrative steps involved in characterizing and calibrating a dynamic spectral filter and in using the calibrated filter in accordance with the present invention.

### DETAILED DESCRIPTION OF THE PREFERRED EMBODIMENTS

The dynamic spectral filters of the present invention may be used whenever it is desired to spectrally modify light. For example, the spectral filters of the present invention may be used in test and measurement equipment or in equipment in which it is desired to produce light with a desired spectral shape or to modify the spectral shape of light provided to the equipment. For illustrative purposes, aspects of the present invention are described in the context of using the dynamic filter in equipment in fiber-optic communications networks. Such equipment may include, for example, optical amplifiers with dynamic gain equalization capabilities and dynamic filter modules.

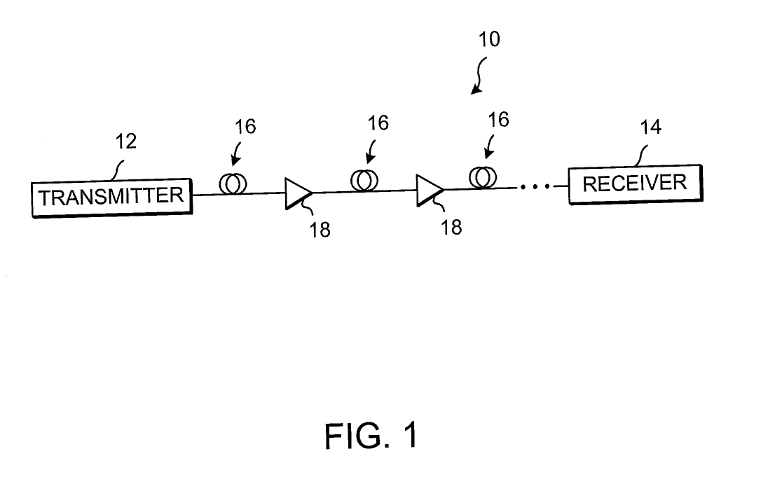

An illustrative fiber-optic communications link 10 in an optical communications network is shown in FIG. 1. A transmitter 12 may transmit information to a receiver 14 over a series of fiber links. Each fiber link may include a span 16 of optical transmission fiber. Fiber spans 16 may be on the order of 40-160 km in length for long-haul networks or may be any other suitable length for use in signal transmission in an optical communications network.

The communications link of FIG. 1 may be used to support wavelength division multiplexing arrangements in which multiple communications channels are provided using multiple wavelengths of light. For example, the link of FIG. 1 may support a system with 40 channels, each using a different optical carrier wavelength. Optical channels may be modulated at, for example, approximately 10 Gbps (OC-192). The carrier wavelengths that are used may be in the vicinity of 1520-1565 nm. These are merely illustrative system characteristics. If desired, more channels may be provided (e.g., hundreds of channels), signals may be carried on multiple wavelengths, signals may be modulated at slower or faster data rates (e.g., at approximately 2.5 Gbps for OC-48 or at approximately 40 Gbps for OC-768), and different carrier wavelengths may be supported (e.g., wavelengths in the range of 1240-1650 nm).

Optical amplifiers 18 may be used to amplify optical signals on link 10. Optical amplifiers 18 may include booster amplifiers, in-line amplifiers, and preamplifiers. Optical amplifiers 18 may be rare-earth-doped fiber amplifiers such as erbium-doped fiber amplifiers, amplifiers that include discrete Raman-pumped coils, semiconductor optical amplifiers, or any other suitable optical amplifiers. For clarity, the present invention will sometimes be described in the context of optically-pumped erbium-doped fiber amplifiers. This is, however, merely illustrative.

Link 10 may include other optical network equipment such as add/drop modules, optical switches, dispersion compensation modules, dynamic filter modules, or any other suitable optical network equipment. If desired, dynamic spectral filters may be used in this equipment.

Taps such as wavelength-insensitive 2%/98% taps or any other suitable taps may be used to tap the light traveling along link 10. The tapped light may be analyzed using optical channel monitors. The optical channel monitors may be located at the same nodes as amplifiers 18, may be located at receiver nodes such as the node at which receiver 14 is located, or may be located at any other suitable position within link 10. The optical channel monitors may be used to make power spectrum measurements. The spectral information from these measurements may be used in controlling the operation of amplifiers 18. If desired, the optical channel monitors may be included in amplifiers 18.

Computer equipment at network nodes such as the nodes at which transmitter 12, amplifiers 18, and receiver 14 are located and computer equipment located at network management facilities may be used to implement a network management system. The network management system may process the spectral information that is gathered by optical channel monitors in link 10. The network management system may also provide network equipment such as amplifiers 18 with information on desired equipment settings. For example, the network management system may provide an optical amplifier 18 with information that defines a desired gain spectrum or output power spectrum for the amplifier to produce. Equipment such as amplifiers 18 may also operate independently using local control arrangements or may be controlled using both the network management system and a local control scheme.

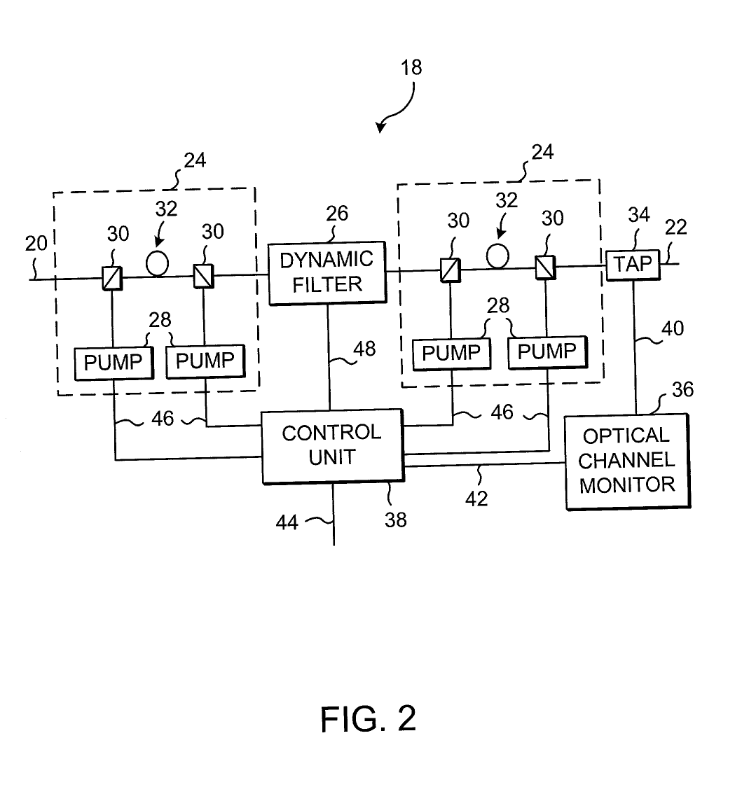

An illustrative optical amplifier 18 having an optical channel monitor 36 is shown in FIG. 2. Optical signals to be amplified (e.g., light from a span of transmission fiber 16 in link 10) may be provided to fiber input 20. Corresponding output signals that have been amplified by amplifier 18 may be provided at fiber output 22.

Optical gain may be provided by one or more gain stages 24. Dynamic filter 26 may be used to modify the spectrum of the amplified light that is provided at output 22. Dynamic filter 26 may be controlled by control unit 38 using path 48. Control unit 38 and dynamic filter 26 may include circuitry (e.g., communications circuitry) that supports communications using path 48. Path 48 may be one or more electrical signal lines or any other suitable communications path. Communications on path 48 may involve analog communications, digital communications, or both analog and digital communications.

The gain stages for amplifier 18 may be based on optically-pumped rare-earth-doped fiber such as erbium-doped fiber or discrete coils of dispersion-compensating fiber or other fiber suitable for discrete Raman amplification, may be based on semiconductor optical amplifiers, or may be based on distributed gain stages in which Raman amplification is provided by optically pumping transmission fiber 16.

In the example of FIG. 2, gain stages 24 include erbium-doped fiber coils 32. Fiber 32 may be optically pumped by pumps 28. Pumps 28 may be one or more laser diode pumps operating at wavelengths of 980 nm or 1480 nm or other suitable wavelengths or any other suitable sources of pump light. Pumps 28 may be controlled by control unit 38 using paths 46. Light from pumps 28 may be directed into coils 32 through pump couplers 30. Pump couplers 30 may be wavelength-division-multiplexing (WDM) couplers or any other suitable pump couplers. The pumping arrangement of FIG. 2 uses copumping and counterpumping. This is merely illustrative. Fiber coils such as coils 32 may be only copumped or may be only counterpumped if desired.

A tap such as tap 34 may be used to tap a portion of the light carried on the main fiber path of amplifier 18. Tap 34 may be, for example, a wavelength-insensitive 2%/98% tap. The tapped optical signals may be provided to optical channel monitor 36 over fiber path 40. Optical channel monitor 36 may measure the power spectrum of the tapped light and may provide information on the measured power spectrum to control unit 38 over electrical path 42.

If an external optical channel monitor is used, information on the spectrum of the light being carried on link 10 may be provided to control unit 38 using a service channel or other suitable communications path on link 10. The information from the external optical channel monitor may be provided to control unit 38 at communications port 44.

Control unit 38 may also receive commands from the network management system using port 44 and a service channel or other suitable communications path between amplifier 18 and the network management system computer equipment.

Control unit 38 may be based on any suitable control electronics and may include one or more microprocessors, microcontrollers, digital signal processors, field-programmable gate arrays or other programmable logic devices, application-specific integrated circuits, digital-to-analog converters, analog-to-digital converters, analog control circuits, memory devices, etc.

The illustrative amplifier 18 in FIG. 2 is somewhat simplified to avoid over-complicating the drawing. In general, amplifier 18 and the other network equipment in link 10 may have additional components such as additional taps for optical monitoring, additional filters such as passive optical filters, wavelength-division-multiplexing couplers, circulators, isolators, attenuators, dispersion-compensating elements, etc.

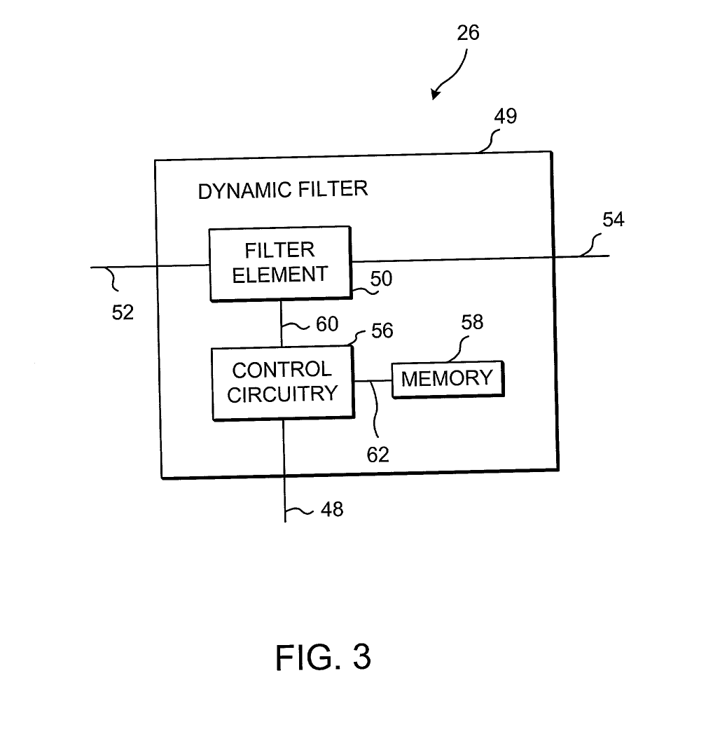

An illustrative dynamic spectral filter 26 is shown in FIG. 3. The components of filter 26 may be mounted using a package 49. Package 49 may be based on a circuit board or other suitable mount or housing. Filter 26 may include a dynamic filter element 50. Filter element 50 may be based on any suitable dynamic filter element arrangement. For example, dynamic filter element 50 may be based on a microelectromechanical systems (MEMS) device, may be based on an acoustooptic device (e.g., an acoustooptic fiber device), may be based on a thermooptic arrayed waveguide device, may be based on a liquid crystal device, may use an electrooptic device, may be based on a semiconductor device, or may be based on any other suitable dynamic filter arrangement. Light that is provided to the input of dynamic filter element 50 via input fiber 52 may be spectrally modified by filter element 50. Corresponding spectrally-modified light may be provided at output fiber 54.

In the example of FIG. 3, dynamic filter element 50 operates in transmission. If desired, filter element 50 may be operated in reflection and a circulator may be used to direct light from fiber input 52 into the element and to direct reflected light from the element to fiber output 54.

Dynamic filter 26 may have control circuitry 56 for controlling filter element 50 using paths such as path 60. Control circuitry 56 may be based on any suitable control electronics and may include one or more microprocessors, microcontrollers, digital signal processors, field-programmable gate arrays or other programmable logic devices, application-specific integrated circuits, digital-to-analog converters, analog-to-digital converters, analog control circuits, memory devices, etc.

Memory 58 may be coupled to control circuitry 56 using path 62. Memory 58 may be any suitable volatile or non-volatile memory such as static random-access memory, dynamic random-access memory, flash memory, programmable read-only memory, erasable programmable read-only memory, electrically-erasable programmable read-only memory, or other suitable memory or combinations of such memory. If memory 58 is based on volatile memory, a battery backup arrangement or other power backup arrangement may be used to preserve information that is stored in memory 58 during interruptions to the main power supply of filter 26.

Memory 58 may be used to store calibration data for dynamic filter 26. The calibration data may be stored in memory 58 at the manufacturing site and may be retrieved in the field by control circuitry 56 during operation of filter 26. In a given filter 26, the calibration data may be used by control circuitry 56 to ensure that a desired spectrum is produced by the filter element 50 in that filter 26, even if the performance of filter elements 50 tends to vary from element to element due to manufacturing variations.

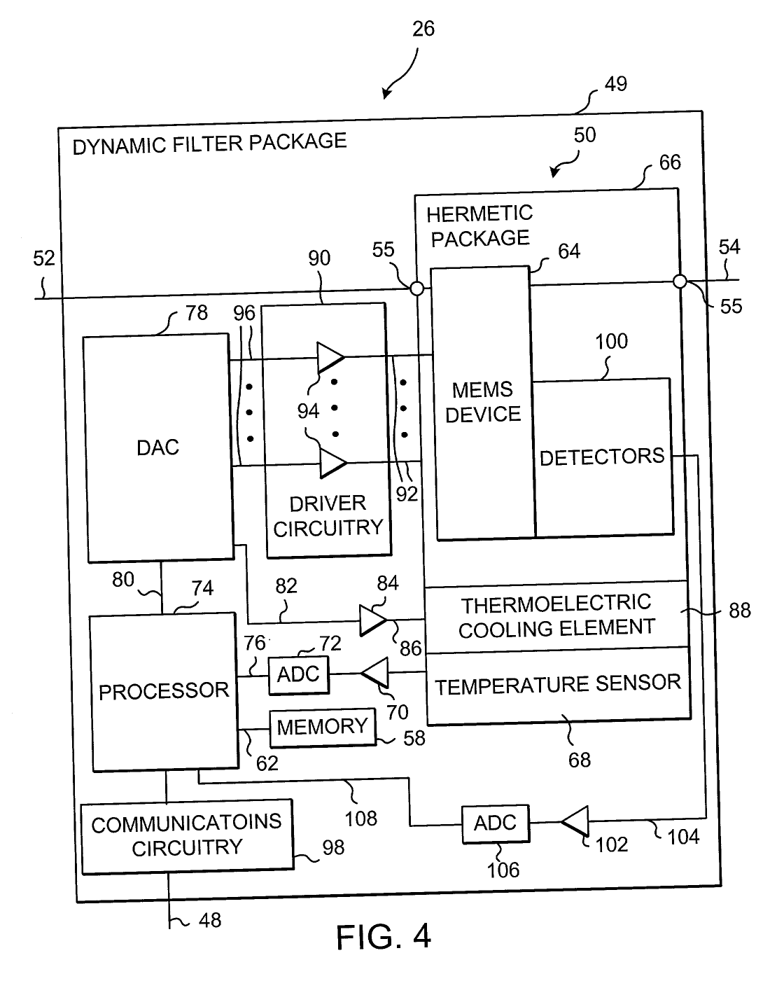

As shown in FIG. 4, filter 26 may include a filter element 50 that is based on a microelectromechanical systems (MEMS) device 64. Device 64 may be housed in a package 66. Package 66 may be a hermitically sealed package and may contain an inert gas for isolating MEMS device 64 from water vapor and other contaminants in the atmosphere. Hermetically sealed fiber pass-through ports 55 may be used to ensure that MEMS device 64 is hermitically isolated within package 66.

The temperature of device 64 may be monitored using a temperature sensor 68. Temperature sensor 68 may be a thermistor, a thermocouple, or any other suitable temperature sensor. Signals from temperature sensor 68 may be conditioned using amplifier 70 and may be digitized using analog-to-digital controller 72. The digitized temperature information from the output of analog-to-digital controller 72 may be provided to processor 74 using path 76.

Processor 74 may include one or more microprocessors, microcontrollers, digital signal processors, field-programmable gate arrays or other programmable logic devices, application-specific integrated circuits, digital-to-analog converters, analog-to-digital converters, analog control circuits, memory devices, etc.

Processor 74 may be coupled to a digital-to-analog converter 78 using paths such as path 80. Digital signals provided to digital-to-analog converter 78 over path 80 may be converted into analog signals for controlling components in filter 26.

For example, processor 74 may use digital-to-analog converter 78 to control the temperature of MEMS device 64. In particular, processor 74 may provide digital signals to digital-to-analog converter 78 that direct digital-to-analog converter 78 to produce an analog voltage signal on line 82. The signal on line 82 may be strengthened into a drive signal (e.g., a current or voltage drive signal) using amplifier 84. The drive signal may be provided to a thermoelectric cooling element 88 or other suitable temperature controller using line 86.

Thermoelectric cooling element 88 may be based on a Peltier effect device and may be used to heat or cool MEMS device 64. If desired, the temperature of device 64 may be monitored using temperature sensor 68 without using a temperature controller to control the temperature of device 64. If the temperature of device 64 is controlled, sensor 68 may be used in a feedback configuration to help processor 74 maintain the device 64 at a desired temperature. If desired, a feedback control loop for controlling the temperature of device 64 may be implemented using control circuitry 56 of filter 26. With this approach, control unit 38 may provide information on a desired temperature to control circuitry 56 and control circuitry 56 may use feedback control techniques to maintain the temperature of device 64 at this temperature during operation of filter 26. The temperature of device 64 may also be controlled using a feedback control loop that is implemented using control circuitry 56 and the processing electronics of control unit 38 in amplifier 18.

MEMS device 64 may be driven using drive signals provided by driver circuitry 90. The drive signals may be provided to device 64 from driver circuitry 90 using lines 92. Driver circuitry 90 may include driver circuits 94. Driver circuits 94 may provide AC or DC drive signals. The spectrum of device 64 (e.g., the transmission or reflection spectrum of device 64) may be controlled by adjusting the amplitudes (and/or frequencies) of each of the drive signals produced by driver circuits 94.

Driver circuitry may be controlled by analog control signals provided from digital-to-analog control circuitry 78 on paths 96. During operation of filter 26, processor 74 may provide digital signals to digital-to-analog controller 78 that digital-to-analog controller 78 converts to analog signals that are provided to driver circuitry 90 using lines 96. Driver circuits 94 create corresponding drive signals that are provided to device 64 over paths 92.

A control unit such as control unit 44 of amplifier 18 in FIG. 2 may be used to provide information to dynamic filter 26 on a desired transmission spectrum for filter 26. The information on the desired filter spectrum may be received by filter 26 over path 48 using communications circuitry 98. Communications circuitry 98 and corresponding communications circuitry in control unit 44 may use any suitable protocol or format for supporting communications over path 48. As an example, serial or parallel digital communications may be used, RS-232 communications may be used, Ethernet communications may be used, or analog signals may be used.

After processor 74 has received the information on the desired spectrum for filter 26 to produce from control unit 44, processor 74 may process this information using the calibration data stored in memory 58 to generate corresponding calibrated control signals for digital-to-analog converter 78.

If desired, detectors 100 may be provided for filter element 64 to measure the power spectrum of the light being provided at fiber input 52. Any suitable arrangement may be used for detectors 100. For example, a detector 100 may be associated with each MEMS component for measuring the light scattered from that component or passed through that component. A detector 100 may also be associated with passive channel taps that are integrated into MEMS device 64 (or other suitable filter element) or the substrate in which MEMS device 64 (or other suitable filter element) is formed. In these arrangements, detectors 100 may serve as an optical channel monitor. Optical channel monitors of this type may be used to measure the input power spectrum for device 64, the output power spectrum of device 64, or both the input and output power spectra. These are merely illustrative examples. If desired, spectral information on the signals for amplifier 18 may be monitored using optical channel monitor 36 or an external optical channel monitor rather than using detectors 100 or in addition to using detectors 100.

Signals from detectors 100 may be provided to electrical amplifiers such as signal conditioning amplifier 102 using path 104. Amplifiers such as amplifier 102 may be transimpedance amplifiers that convert current from detectors 100 into voltage signals for analog-to-digital converter 106. The digital output of analog-to-digital converter 106 may be provided to processor 74 for use in controlling the operation of filter 26.

Control circuitry 56 may be used to implement a local feedback control loop in which feedback signals from detectors 100 or other suitable internal optical channel monitor arrangement are used to control the operation of dynamic filter element 50. With this approach, control unit 38 need only provide control circuitry 56 with desired spectral information or other suitable information that may be used in defining the desired spectral characteristics for filter 26. As an example, control unit 38 may provide control circuitry 56 with information on a desired output power spectrum to be produced at the output of filter 26. During operation of filter 26, control circuitry 56 may use the information from detectors 100 or other internal optical channel monitor equipment to adjust the transmission spectrum of filter element 50 accordingly. Control unit 38 need not be used in this feedback control loop except to periodically provide information to filter 26 that is used in controlling filter 26 to produce desired spectral characteristics.

Using control circuitry 56 to control the spectrum produced by filter element 50 based on feedback signals from detectors 100 or other optical channel monitor equipment allows filter 26 to accurately control the spectrum of amplifier 18. This type of feedback approach may be used in filters 26 that are calibrated by storing calibration data in memory 58 or may be used in filters 26 that are not calibrated in this way or that are uncalibrated.

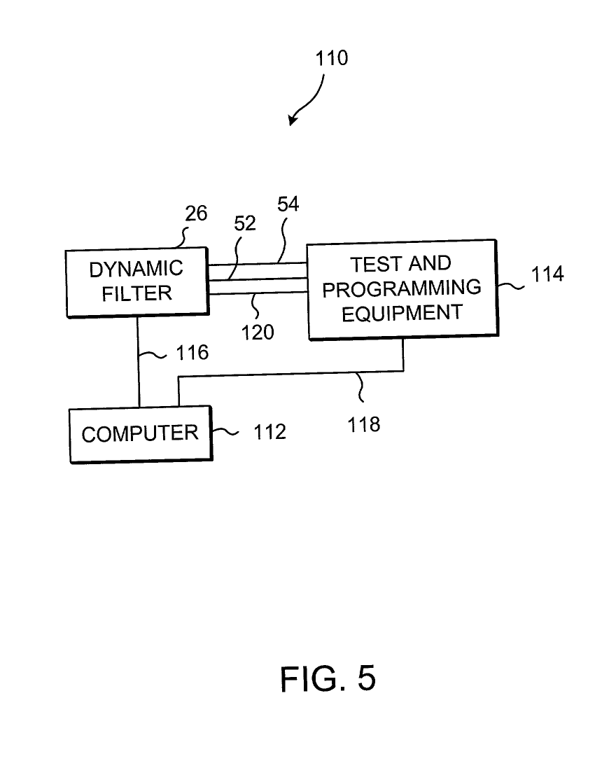

An illustrative setup for characterizing and calibrating filter 26 is shown in FIG. 5. Operation of characterization and calibration system 110 may be coordinated using computer 112. Computer 112 may be one or more personal computers, embedded or stand-alone microprocessor-controlled modules, or any other suitable control equipment.

Computer 112 may control the operation of a dynamic spectral filter 26 that is being characterized and calibrated using path 116. Computer 112 may also control the operation of one or more pieces of test and programming equipment 114 using path 118. If desired, the functions of computer 112 may be performed using control units that are included in equipment 114 with or without using computer equipment 112.

Test and programming equipment 114 may include any suitable equipment for controlling the operation of dynamic filter 26, for characterizing the performance of dynamic filter 26 in response to various control signals, and for storing calibration information in dynamic filter 26 (e.g., in memory 58) after dynamic filter 26 has been characterized. Equipment 114 and computer 112 may be electrically connected to dynamic filter 26 using electrical paths 116 and 120. Communications circuitry 98 may be used by filter 26 to communicate with equipment 114 and computer 112.

Equipment 114 may include an optical source such as a tunable laser diode, a bank of multiple laser diodes each of which operates at a different wavelength, or a broadband source such as light-emitting diode source or amplified spontaneous emission (ASE) source. The light from the source in equipment 114 may be provided to fiber input 52 of filter 26. The resulting spectrally modified output light from filter 26 may be provided to test and programming equipment 114 over fiber output 54. Equipment 114 may include an optical spectrum analyzer or other suitable detector arrangement for measuring the spectrum of the light received from fiber output 54.

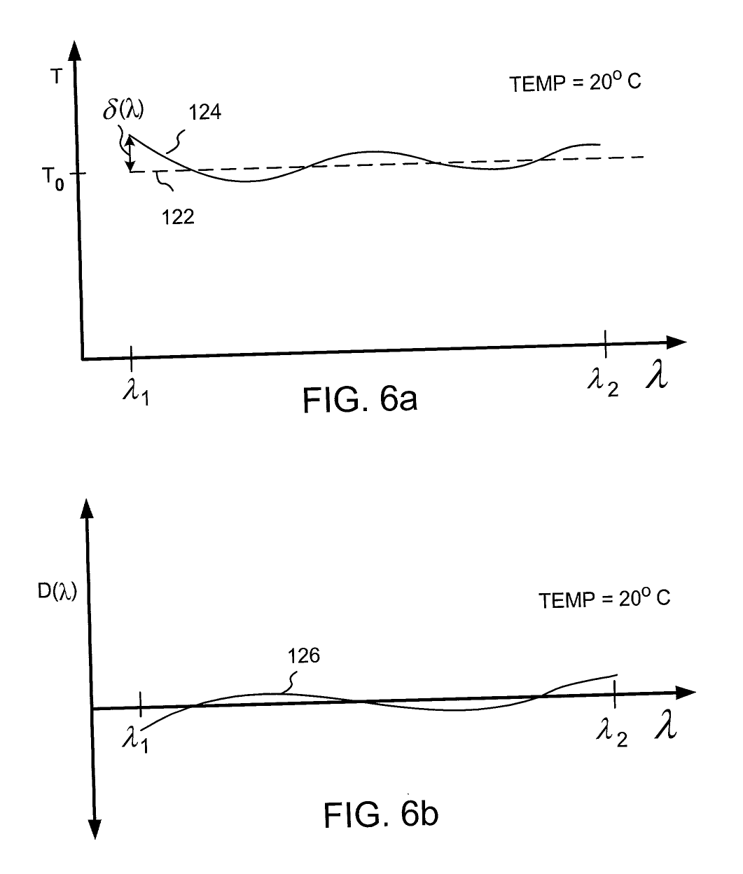

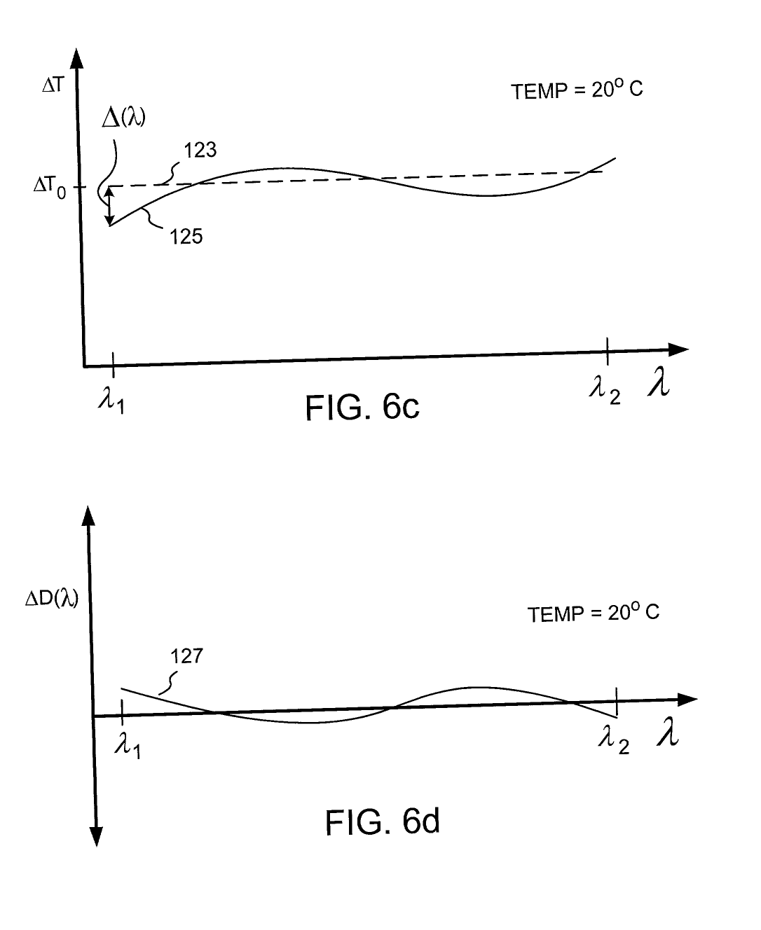

Computer 112 and equipment 114 may direct dynamic filter 26 to produce a desired nominal transmission spectrum (or a desired reflection spectrum if filter 26 is operated in reflection). An illustrative desired nominal transmission spectrum is given by the flat dotted line 122 in FIG. 6a. The spectrum of line 122 has a constant transmission of T₀. While filter 26 is attempting to produce the nominal transmission spectrum given by line 122, equipment 114 may provide test light to filter 26 and may measure the actual transmission spectrum that is produced by filter 26. The actual transmission spectrum that a given filter 26 may produce when attempting to generate the transmission spectrum of line 122 is given by line 124.

Test and programming equipment 114 and computer 112 may be used to calculate the difference spectrum δ(λ) between the nominal desired spectrum and the actual spectrum. The errors associated with the difference spectrum δ(λ) may be nullified by using the corrective control signal spectrum D(λ) given by line 126 of FIG. 6b during operation of filter 26 in a system.

The control signal spectrum 126 may be calculated by computer 112 and equipment 114 from the measured values of δ(λ) . If desired, the control signal spectrum 126 may be measured directly by using feedback to adjust filter 26 until the actual spectrum 124 and desired spectrum 122 match and then recording the control signals that are used to achieve this match. The control signals D(λ) may represent DC or AC voltages or currents, AC signal frequencies, combinations of DC signals and AC signals at different frequencies and amplitudes, or any other suitable drive or control signals. The control signal information D(λ) may be used as calibration data during the operation of filter 26 by, for example, adding (or subtracting) these signals to the set of control signals being used to control fiber element 50 to produce a desired spectrum. The programming or other storage capabilities of test and programming equipment 114 may be used to program (store) the calibration data into memory 58 of filter 26.

The illustrative measurements of FIGS. 6a and 6b may be taken at a fixed temperature (e.g., the operating temperature of filter 26 when filter 26 is temperature controlled), or may be taken at multiple temperatures (e.g., when the temperature of filter 26 is expected to vary during operation). The temperature dependence of the spectral measurements may also be used as calibration data and may be stored in memory 58 by equipment 114 if desired. Although the example of FIGS. 6a and 6b involves using a flat target spectrum 122, one or more target spectra of any suitable shapes may be used during calibration measurements.

During some operations, it may be desirable to direct filter 26 to produce an incremental change to the current spectrum. For example, it may be desired to add a fixed amount of attenuation across the entire filter spectrum. Test and programming equipment 114 and computer 112 may be used to determine the difference spectrum Δ(λ) between a nominal desired incremental spectrum change (e.g., line 123 in FIG. 6c) and the actual incremental spectrum change (line 125 in FIG. 6c) under various operating conditions. The errors associated with the difference spectrum Δ(λ) may be nullified by using the corrective control signal spectrum ΔD(λ) given by line 127 of FIG. 6d during operation of filter 26 in a system.

The control signal spectrum 127 may be calculated by computer 112 and equipment 114 from the measured values of Δ(λ). If desired, the control signal spectrum 127 may be measured in a series of spectral measurements in which feedback is used to adjust filter 26 until the actual spectra produced by filter 26 match each of a number of desired spectra and in which the resulting control signals that are used to achieve these matches are recorded.

The control signals ΔD(λ) may represent DC or AC voltages or currents, AC signal frequencies, combinations of DC signals and AC signals at different frequencies and amplitudes, or any other suitable drive or control signals. The control signal information ΔD(λ) may be used as calibration data during the operation of filter 26 by, for example, adding (or subtracting) these signals to the set of control signals being used to control fiber element 50 to produce a desired incremental change in spectrum. The programming or storage capabilities of test and programming equipment 114 may be used to program (store) the calibration data in memory 58 of filter 26.

The illustrative measurements of FIGS. 6c and 6d may be taken at a fixed temperature (e.g., the operating temperature of filter 26 when filter 26 is temperature controlled), or may be taken at multiple temperatures (e.g., when the temperature of filter 26 is expected to vary during operation). The temperature dependence of the spectral measurements of FIGS. 6c and 6d may also be used as calibration data and may be stored in memory 58 by equipment 114 if desired. Although the example of FIGS. 6c and 6d involves using a flat target incremental change in spectrum 123, one or more target spectra of any suitable shapes may be used during calibration measurements.

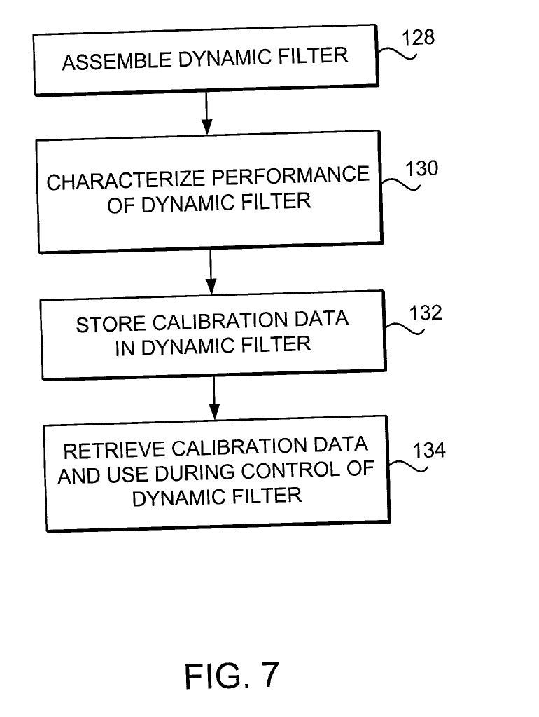

Illustrative steps involved in characterizing and calibrating dynamic filter 26 are shown in FIG. 7. At step 128, some or all of the components of filter 26 may be assembled.

At step 130, computer 112 and equipment 114 may be used to direct filter 26 to produce one or more desired nominal (target or test) spectra and to measure the actual spectrum or spectra that result. Filter 26 may also be directed to produce various nominal incremental spectral changes. If filter 26 has a temperature controller, the temperature of filter 26 may be varied internally. The temperature of filter 26 may also be varied using an external heater in equipment 114. External temperature measurements or temperature measurements made using an internal temperature sensor such as temperature sensor 68 may be made during the spectral measurements to determine the temperature dependence of the measurements.

The measurements made during step 130 may be used by computer 112 and equipment 114 to characterize the operation of filter 26 as a function of applied control signal spectrum, temperature, etc. The results of the characterization may be used to create calibration data. The calibration data may be used to determine exactly which calibrated control signals should be applied to the filter element 50 of filter 26 during operation to produce a particular desired filter spectrum.

At step 132, computer 112 and test and programming equipment 114 may be used to store the calibration data in memory 58. In general, the results of each calibration test are different, because the components of filter 26 differ from assembly to assembly. The unique calibration data that is stored in each filter 26 may be used during operation of filter 26 in equipment such as optical amplifier 18 to ensure that all filters 26 behave identically from the perspective of external control circuits such as control unit 44.

At step 134, when filter 26 is used in an amplifier 18 or other suitable optical network equipment, a control unit 44 or other suitable controller may issue a command or send signals to dynamic filter 26 that direct dynamic filter 26 to produce a desired spectrum. Control circuitry 56 (processor 74) may process the information on the desired spectrum to determine the actual calibrated control signals to apply to filter element 50. The actual calibrated control signals that are to be used may be determined by processing information on the desired spectrum and environmental data such as temperature data, and by using the calibration data. With this approach, the nominal uncalibrated control signals that would otherwise be used to control filter element 50 to produce a desired spectrum may be calibrated by control circuitry 56 (processor 74) and the calibrated signals used to control filter 26.

When control circuitry 56 uses feedback signals from detectors 100 or other optical channel monitoring equipment to implement a feedback control loop that is used to control the operation of filter element 50, dynamic filter 26 need not be calibrated. Accordingly, steps 130 and 132 may be omitted and dynamic filter 26 may be controlled at step 134 using feedback without using calibration data.

If desired, feedback control techniques may be used by a calibrated dynamic filter 26. With this approach, the filter 26 may be assembled and characterized at steps 128 and 130. Calibration data may be stored at step 132. The control circuitry 56 may use feedback signals from detectors 100 or other optical channel monitoring equipment and the calibration data in controlling the dynamic filter at step 134.

It will be understood that the foregoing is merely illustrative of the principles of this invention, and that various modifications can be made by those skilled in the art without departing from the scope and spirit of the invention.

What is claimed is:

1. A calibrated dynamic spectral filter for filtering light in fiber-optic communications equipment, comprising:
a dynamic filter element;
memory in which calibration data for the dynamic filter element is stored; and
control circuitry that controls the dynamic filter element using the calibration data stored in the memory.

2. The calibrated dynamic spectral filter defined in claim 1 further comprising a housing for the dynamic spectral filter.

3. The calibrated dynamic spectral filter defined in claim 1 wherein the memory comprises flash memory.

4. The calibrated dynamic spectral filter defined in claim 1 wherein the calibration data includes spectral information on the performance of the dynamic filter element.

5. The calibrated dynamic spectral filter defined in claim 1 wherein the calibration data includes temperature dependence information on the performance of the dynamic filter element.

6. The calibrated dynamic spectral filter defined in claim 1 further comprising a temperature sensor coupled to the dynamic filter element.

7. The calibrated dynamic spectral filter defined in claim 1 further comprising communications circuitry for supporting communications with a control unit in an optical amplifier.

8. An optical amplifier for amplifying optical signals in a fiber-optic communications network comprising:
at least one gain stage that provides optical gain for the optical signals;
a calibrated dynamic spectral filter that spectrally filters the optical signals; and
a control unit that controls the operation of the gain stage and the calibrated dynamic spectral filter, wherein the calibrated dynamic spectral filter includes a dynamic filter element, memory in which calibration data for the dynamic filter element is stored, and control circuitry that controls the dynamic filter element using the calibration data stored in the memory in response to communications that the control circuitry receives from the control unit.

9. The optical amplifier defined in claim 8 further comprising a housing for the dynamic spectral filter.

10. The optical amplifier defined in claim 8 wherein the memory comprises flash memory.

11. The optical amplifier defined in claim 8 wherein the calibration data includes spectral information on the performance of the dynamic filter element.

12. The optical amplifier defined in claim 8 wherein the calibration data includes temperature dependence information on the performance of the dynamic filter element.

13. The optical amplifier defined in claim 8 further comprising a temperature sensor coupled to the dynamic filter element.

14. The optical amplifier defined in claim 8 wherein the control unit is configured to receive information on a desired spectrum for the optical amplifier from a network management system.

15. The optical amplifier defined in claim 8 wherein the control circuitry is configured to support digital communications with the control unit.

16. The optical amplifier defined in claim 8 wherein the dynamic filter comprises driver circuitry that produces a plurality of voltage drive signals to control the dynamic filter element and wherein the dynamic filter element is a microelectromechanical systems device.

17. A method for providing a calibrated dynamic spectral filter for use in an fiber-optic communications system, comprising:
assembling components to form the dynamic filter;
using test equipment to characterize the performance of a dynamic filter element in the dynamic filter; and
storing calibration data in the dynamic filter, wherein the calibration data is based on the characterization of the performance of the dynamic filter element.

18. The method defined in claim 17 wherein storing the calibration data comprises storing the calibration data in memory in the dynamic filter using programming equipment.

19. The method defined in claim 17 wherein storing the calibration data comprises storing the calibration data in non-volatile memory in the dynamic filter using programming equipment.

20. The method defined in claim 17 wherein the calibration data includes information on a difference spectrum between a nominal spectrum to which the dynamic filter was set and an actual spectrum that was measured by the test equipment.

21. A dynamic spectral filter for filtering light in fiber-optic communications equipment, comprising:
a dynamic filter element;
optical detectors;
control circuitry that controls the dynamic filter element using the information from the optical detectors.

22. The dynamic spectral filter defined in claim 25 further comprising:
a housing for the dynamic spectral filter;
a thermoelectric cooling element connected the dynamic filter element; and
a temperature sensor for measuring the temperature of the thermoelectric cooling element, wherein the control circuitry is configured to control the temperature of the thermoelectric cooling element based on temperature measurements from the temperature sensor.
